(19) United States
(12) Patent Application Publication
(10) Pub. No.: US 2009/0241648 A1
(43) Pub. Date: Oct. 1, 2009

(54) Reducing Noise In Atomic Force Microscopy Measurements

(75) Inventors: Michael Dieudonne, Leuven (BE); Gerald Kada, Linz (AT); Tianwei Jing, Tempe, AZ (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/058,769

(22) Filed: Mar. 31, 2008

(51) Int. Cl. G12B 21/20; G01B 5/28

(52) U.S. Cl. 73/105; 250/307

(57) ABSTRACT

Exchanging data between an Atomic Force Microscopy (AFM) measuring device and an external controlling device using a wireless link. The wireless link replaces cables leading to the AFM measuring device and thereby mitigates mechanical noise vibrations. The controlling device can be an AFM controller, a PC workstation, a keyboard or a pointing device. A power supply and cables to provide power to the measuring device can be replaced with a battery power source to further mitigate mechanical noise. The AFM measuring device can reside in a vibration isolation chamber along with the power source and AFM controller to further isolate noise.

### BACKGROUND OF THE INVENTION

Atomic Force Microscopy (AFM) is a high-resolution imaging technique that can resolve features as small as an atomic lattice in real space. It allows researchers to observe and manipulate molecular and atomic level features.

AFM measurement requires a vibration free environment as every vibration is amplified, thereby leading to a distorted result set. Several techniques exist in order to avoid any type of resonance of the complete AFM setup. An example of such a technique is from Agilent Technologies, Inc. of Santa Clara, Calif. Agilent Technologies sells a vibration isolation chamber as an optional accessory with an AFM measuring device (known as a microscope). The chamber combines acoustic isolation and delivers less than 1 Hz noise resonance. The vibration isolation chamber is compact and permits atomic-resolution imaging in noisy environments.

FIG. 1 is a diagrammatic representation of an AFM laboratory setup 100. The laboratory setup 100 comprises a vibration isolation chamber 101. An AFM measuring device 105 resides within the isolation chamber 101.

The AFM measuring device 105 is controlled by an external controlling device 160. The external controlling device 160 refers to communication equipment that controls the AFM measuring device 105. The external controlling device typically resides outside the chamber 101. The external controlling device 160 can comprise a Personal Computer (PC) workstation 141 or a computer input device 149 or both. The computer input device 149 can be a pointing device or a keyboard. The external controlling device can also comprise an AFM controller 109 with an attached pointing device or a keyboard (not shown). The external controlling device 160 can also combine the functions of the PC workstation 141 and the AFM controller 109.

In FIG. 1, the AFM controller 109 interfaces with the measuring device 105 at a high interrupt handling rate. The workstation 141 enables an operator to interact with the AFM controller 109 through a user-friendly graphical user interface (not shown). The workstation 141 is connected to the AFM controller by an electronic cable 139.

Also depicted in FIG. 1 is a power supply 143 connected to the measuring device 105. The power supply can be integrated into the external controlling device 160, in this instance the AFM controller 109, but is drawn in FIG. 1 as two separate units. The power supply 143 and the external controlling device 160 both reside outside the isolation chamber 101 and are connected to the measuring device 105 through cables 119. The cables 119 pass through a side-window 135 of the chamber 101.

The cables 119 comprise serial and data cables 133 for bi-directional data signal transfer, and a power cable 131. The parallel cable can be, for example a DB44 data cable or a DB9 high voltage cable. The data signals transferred between the controller 109 and the device 105 comprise signals to control the AFM laser, to position the cantilever tip, and signals that represent measurement results. The cables 119 are bulky and relatively stiff due their large cross sectional area.

When performing high-resolution measurements (e.g. at the Angstrom level (0.1 nm resolution)), the minutest of vibrations can induce errors in the measured results.

The cables 119 are subject to mechanical vibration induced by the environment outside the isolation chamber 101. Noise induced by footsteps, by cooling fans of electronic equipment (the power supply 143 or the workstation 141) in the proximity of the chamber 101, or by an air-conditioning unit to cool the laboratory are examples of mechanical noise induced onto the cables 119. Cognizant of the effects of mechanical noise, the operator will position the AFM controller 109 in the near vicinity of isolation chamber 101 to keep the cables 119 to a minimum length to mitigate mechanical noise through the cables 119.

Presently two solutions exist to reduce the mechanical noise entering the isolation chamber 101 through the cables 119. These include: i) removing the insulation jacket of the cables 119 to allow more flexibility; and ii) replacing the data cable 133 with a flexible flat ribbon cable to reduce the stiffness of the data cable 133.

However, the two solutions only partially solve the mechanical noise problem and have disadvantages associated with them. Cutting the insulation jacket of the cables 119 and leaving them exposed does not present a professional solution. Removing the insulation jacked of the data cable 133 can have unwanted electro-magnetic interference (EMI) consequences and induce error in the data signals. Flexible flat ribbon cables do not have a robust EMI shield and would not offer a viable solution.

An alternative option of replacing the data cable 133 with an infrared (IR) link has been investigated. Unfortunately, this solution was not successful. The infrared link between the AFM measuring device 105 and the external controlling device 160 does not enable the two devices to communicate effectively. As an IR link requires a direct and clear path between the remote sensor head and the measuring device 109, this option could not be implemented efficaciously.

Another concern common to layout of the laboratory setup 100 is an arduous alignment process. In the laboratory setup 100, the external controlling device 160 and the visual verification of the AFM measuring device 109 cantilever tip do not facilitate an efficient working environment. As mentioned above, the operator of the AFM measuring device 105 will position the AFM controller 109 in the immediate vicinity of the isolation chamber 101 to keep the cables 119 to a minimum length to mitigate mechanical noise through the cables 119. Often, the PC workstation 141 is placed in a different location.

This inconveniences the operator by having to going back and forth between workstation 141 and the chamber 101 in order to adjust the AFM measuring device 105 head and move the cantilever tip to the region of interest. The present setup adds a disproportionate setup time to an AFM measurement.

Contemporary laboratories are designed to allow operators to work in a distributed environment. This helps reduce cost by not having the workstation 141 dedicated to the AFM measurement system 111. Having a distributed environment would allow the AFM controller 109 to be accessed by multiple workstations, thereby allowing the AFM measuring device 101 to be centrally located but remotely accessible to multiple scientists.

Accordingly, a need exists to further reduce the noise induced onto the AFM measuring device 105, to improve the ease in which the AFM measuring device 105 can be controlled, and to reduce the cost associated with accessing the AFM device 105 remotely.

### BRIEF DESCRIPTION OF THE DRAWINGS

FIG. 1 is a diagrammatic representation of an AFM laboratory setup of the prior art;

FIGS. 2A-B describe an AFM measuring device and an external controlling device communicating through a wireless link;

FIG. 3 describes the AFM measuring device and an external controlling device communicating through a wireless link, and utilizing a battery power source; and

FIG. 4 is a flow chart showing steps for setting up the AFM test apparatuses of the present invention.

### DETAILED DESCRIPTION

The solutions described herewith reduce the mechanical vibration noise (“mechanical noise”) by replacing the stiff parallel cable 133 with a wireless link between the external controlling device 160 and the AFM measuring device 105. In addition to this, the power supply 143 and power cables 131 can be replaced with a battery power source. The individual solutions can also be implemented independently.

By implementing a wireless link, a concomitant benefit of improving the ease of use is addressed.

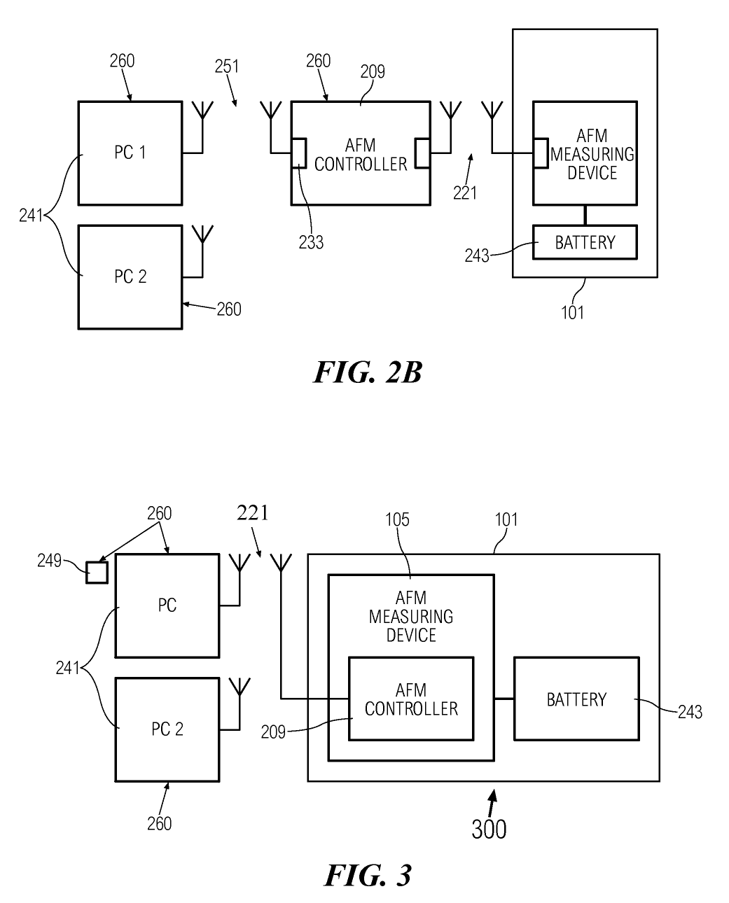

FIGS. 2A and 2B are diagrams illustrating an AFM laboratory setup 200 employing the solutions described above.

FIG. 2A describes the isolation chamber 101 housing the AFM measuring device 105 and a wireless transceiver 227. The wireless transceiver 227 can be integrated into the AFM measuring device 105 or remain as a separate unit.

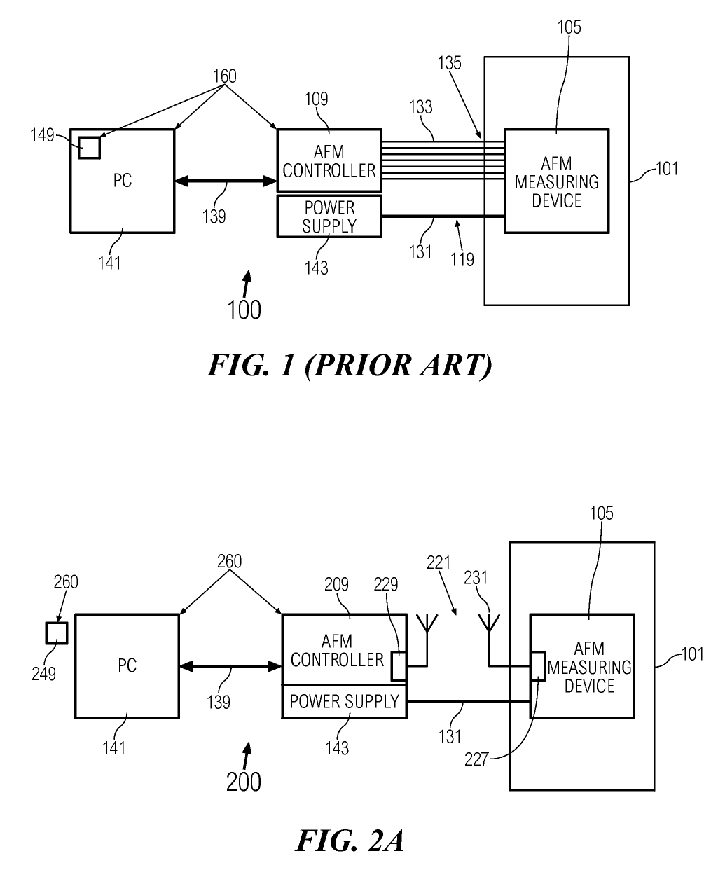

The wireless transceiver 227 is connected to an antenna 231 fitted on the interior or exterior of the chamber 101. When fitted inside the chamber, the mechanical isolation can be maximized. When the antenna is located outside the chamber, the cables can pass through the side-window 135 (FIG. 1).

FIG. 2A depicts an external controlling device 260 which communicates with the AFM measuring device 105. The external controlling device 260 comprises the PC workstation 141, a computer input device 249, and an AFM controller 209.

The PC workstation 141 communicates with the AFM controller 209 through the electronic cable 139. The AFM controller 209 is wireless enabled. The AFM controller 209 is similar to the AFM controller 109 in FIG. 1 and has a wireless transceiver 229 either integrated into its design or as a stand-alone unit. The AFM measuring device 105 is linked to the AFM controller 209 through a first wireless transmission link 221.

The wireless link 221 enables effective communication between the AFM measuring device 105 and the external controlling device 260 as wireless protocol allows for fast interrupt handling requirements of the AFM measuring device 105. Furthermore, the compact, power sensitive, and low noise characteristics of the wireless transmitter 227, enable the transmitter 227 to be incorporated into the AFM chamber 101 or incorporated into the AFM measuring device 105.

FIG. 2A describes a power management setup similar to that of FIG. 1. The power supply 143 is external to the AFM chamber and is connected to the AFM measuring device 105 through a cable 131.

The AFM setup 200 can be used when measuring both non-magnetic and magnetic sensitive material measurement. Wireless transmission link protocols for the wireless link 221 can be short range high speed communications, for example Wireless Local Area Network, Ultra Wideband or Bluetooth. These wireless protocol can offer optimal mechanical isolation.

FIG. 2B describes an AFM laboratory setup 201 similar to that of FIG. 2A. The external controlling device 260 comprises two PC workstations 241 and the AFM controller 209. A second wireless link 251 to pass signals within the components that comprise the external controlling device 260, in this instance between the AFM controller 209 and two workstations 241. The AFM controller 209 is fitted with a second wireless transmitter 233 to access the second wireless link 251.

The two workstations 241 can share control and access of the AFM measuring device 105 through the wireless AFM controller 209. The second wireless link 251 can be the same or different protocol as the wireless link 221 (between the AFM controller 209 and the AFM measuring device 105). When the protocol used in the wireless link 251 and 221 are the same, the PC Workstation 241 can directly control the AFM measuring device 105. This is particularly useful for a coarse grain experiment setup.

FIG. 2B also describes a battery power source 243 within the chamber 101. The battery power source 243 replaces the power supply 143 and power cable 131 of FIG. 2A. The battery power source 251 supplies the requisite DC power to the measuring device 105.

The replacement of the data cables 133 by the wireless link 221 and the power supply and cable 131 with the battery power source 243 mitigates mechanical noise.

FIG. 3 describes yet another solution to mitigate mechanical noise. In the laboratory setup 300 of FIG. 3, the AFM measuring device 105, the AFM controller 209 and the power supply 243 fit within the AFM chamber 101. The AFM controller 209 is part of the AFM measuring device 105.

The external controlling device 260 comprises the two PC workstations 241 and the computer input device 249. The wireless link 221 connects the AFM controller 209 and the external controlling device 260, in this instance, the workstations 241 and the computer input device 249. The battery power source 243 supplies the requisite DC power to the measuring device 105 and the AFM controller 209.

With the solutions offered in FIGS. 2A-B and 3, the concern of improving the ease of use is also addressed.

With the wireless links 221 and 251, the operator can maneuver the PC workstation 241 to within a safe distance of the opening of the chamber 101 to visually position the cantilever tip of the measuring device 105.

In a distributed PC network of FIG. 2B and FIG. 3, a portable PC workstation (from one of the PC workstations 241) can be used to position the cantilever tip of the AFM measuring device 105.

FIGS. 2A and 3 also describe a secondary wireless setup between the computer input device 249 and the PC workstation 241. Examples of a computer input device are a keyboard, a pointing device, or a joystick. The computer input device 249 can be used as the external controlling device 260 to aid the operator to position the cantilever tip of the measuring device 105. The operator can take computer input device 249 to within a safe distance of the opening of the chamber 101 to visually position the cantilever tip of the measuring device 105. The secondary wireless setup can be a Bluetooth connection, an Ultra Wideband connection, or another short range wireless air interface. For example, the external controlling device 260 can be a regular cellular phone where the keyboard is assigned as remote control functionality. The external controlling device 260 can also be a wireless joystick.

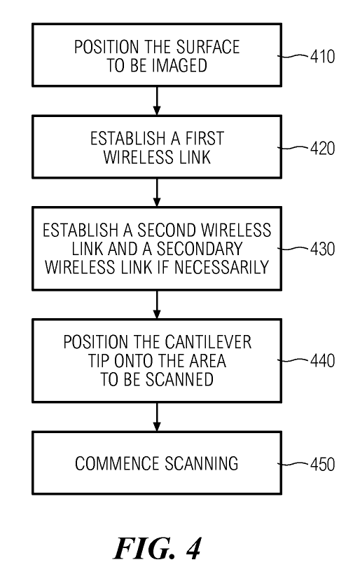

FIG. 4 is a flow chart showing steps for setting up the AFM test apparatuses of the present invention. Block 410 describes positioning the surface to be imaged under the cantilever tip of the AFM measuring device 105 using an AFM setup of FIG. 2A, 2B or 3.

Block 420 describes establishing the first wireless link 221 between the AFM measuring device 105 and the external controlling device 260 by powering on the respective devices. The measuring device can be powered by a battery power source.

Block 430 describes establishing a second wireless link 251 and a secondary wireless link if necessarily to provide a communication link to equipment to control the AFM measuring device 105.

Block 440 describes using a computer pointing device 249 or the PC workstation 241 to position the cantilever tip onto the area to be scanned.

Block 450 describes finalizing the setup, closing the isolation chamber door and commence the AFM scanning.

While the embodiments described above constitute exemplary embodiments of the invention, it should be recognized that the invention can be varied in numerous ways without departing from the scope thereof. It should be understood that the invention is only defined by the following claims.

1. A method for exchanging data in an Atomic Force Microscopy (AFM) setup, the AFM setup comprising an AFM measuring device and an external controlling device, the method comprising passing signals over a first wireless link between the AFM measuring device and the external controlling device, the signals being used to convey results measured by the AFM measuring device or to control the AFM measuring device.

2. The method of claim 1, wherein the external controlling device comprises an AFM controller.

3. The method of claim 2, wherein the AFM measuring device and the AFM controller are within an isolation chamber.

4. The method of claim 1, wherein the external controlling device comprises a workstation.

5. The method of claim 1, wherein the external controlling device includes multiple workstations for controlling the AFM measuring device.

6. The method of claim 1, wherein the external controlling device comprises a computer input device.

7. The method of claim 1, wherein the AFM measuring device is within an isolation chamber.

8. The method of claim 1, further comprising the step of powering the AFM measuring device with a battery power supply.

9. The method of claim 8, wherein the AFM measuring device and the battery power supply are within an isolation chamber.

10. The method of claim 1, further comprising the step of communicating between the components of the external controlling device through a second wireless link.

11. An Atomic Force Microscopy (AFM) setup comprising:
an AFM measuring device and an external controlling device, the AFM setup exchanging data by passing signals over a first wireless link between the AFM measuring device and the external controlling device, the signals being used to convey results measured by the AFM measuring device or to control the AFM measuring device.

12. The AFM setup of claim 11, wherein the external controlling device is an AFM controller.

13. The AFM setup of claim 12 wherein the AFM measuring device and the AFM controller are within an isolation chamber.

14. The AFM setup of claim 11, wherein the external controlling device is a workstation.

15. The AFM setup of claim 11, wherein the external controlling device comprises a computer input device.

16. The AFM setup of claim 15, wherein the computer input device is connected to a workstation by a secondary wireless link.

17. The AFM setup of claim 11, wherein the external controlling device comprises a joystick.

18. The AFM setup of claim 11, wherein the AFM measuring device is within an isolation chamber.

19. The AFM setup of claim 11, further comprising a battery power supply to power the AFM measuring device.

20. The AFM setup of claim 11, wherein components of the external controlling device communicate by a second wireless link.
